(19) United States
(12) Patent Application Publication
(10) Pub. No.: US 2026/0220636 A1
(43) Pub. Date: Jul. 30, 2026

(54) Method for securing the entry of personal identification code digits, and corresponding device

(71) Applicant: BANKS AND ACQUIRERS INTERNATIONAL HOLDING, SURESNES (FR)

(72) Inventor: Jérome GRANDEMENGE, PARIS (FR)

(21) Appl. No.: 19/141,797

(22) PCT Filed: Dec. 20, 2023
(86) PCT No.: PCT/EP2023/087154

§ 371 Date: Jun. 20, 2025

(30) Foreign Application Priority Data
Dec. 22, 2022 (FR) FR2214213

(51) Int. Cl. G06Q 20/40

(52) U.S. Cl. CPC G06Q 20/4012

(57) ABSTRACT

A method for adaptively securing entry of digits of a personal identification code, called a PIN code, on a mobile terminal configured to communicate with a server. The method is implemented by the server and includes: receiving information transmitted by the mobile terminal, the information enabling to define a security level of the mobile terminal, a type of the information being predetermined or determined by the server in a request sent by the server to the mobile terminal; processing the information to determine a risk level; determining a display mode based on the risk level; transmitting to the mobile terminal display instructions based on the determined display mode, the display instructions ensuring a display according to the display mode of entry zones of elements of the PIN code on a display screen of the mobile terminal, when the display instructions are executed by a processor of the mobile terminal.

### CROSS-REFERENCE TO RELATED APPLICATIONS

This Application is a Section 371 National Stage Application of International Application No. PCT/EP2023/087154, filed Dec. 20, 2023, and published as WO 2024/133603 A1 on Jun. 27, 2024, not in English, which claims priority to and the benefit of French Patent Application No. 2214213, filed Dec. 22, 2022, the contents of which are incorporated herein by reference in their entireties.

### FIELD OF THE DISCLOSURE

The present invention concerns the field of payment applications, and in particular software applications configured to transform a commercial mobile terminal intended for the general public into a payment terminal.

### BACKGROUND OF THE DISCLOSURE

It is known to use a software application to transform a commercial mobile terminal intended for non-professional customers, for example, a smart phone, in particular a smartphone type, into a payment terminal. Said software application implements a method configured to guarantee the confidentiality of the personal identification code (PIN) entered on the mobile terminal to authenticate the payment card holder.

To this end, it is more particularly known to mix the relative positions, on the terminal screen, of the zones used to enter the different digits of the PIN code, so that these relative positions are different for a new transaction from what they were for the previous transaction. Said positions are determined randomly by a server distinct from the mobile terminal; thus, these provisions make it possible to defend against an attack via an auxiliary channel such as listening to terminal sensors, for example listening to an accelerometer or a gyroscope to guess the numbers entered for the PIN code.

This known solution, however, has the disadvantage of being uncomfortable for the user and unsuitable for visually impaired users.

### SUMMARY

The invention therefore aims to provide a solution to all or part of these problems.

To this end, the present invention concerns a method for adaptively securing the entry of the digits of a personal identification code, called PIN code, on a mobile terminal configured to communicate with a server, the method comprising the following steps implemented by the server:
receiving information transmitted by the mobile terminal, the transmitted information making it possible to define a security level for the mobile terminal, a type of transmitted information being predetermined, or determined by the server in a request sent by the server to the mobile terminal;
processing the information transmitted by the mobile terminal to determine a risk level
determining a display mode based on the risk level;
transmitting to the mobile terminal display instructions determined by the server based on the determined display mode, the display instructions being configured to ensure display according to the display mode of the PIN entry zones on a display screen of the mobile terminal.

According to these provisions, the PIN entry is possible for visually impaired people, and the security associated with the PIN entry is ensured by other means.

According to one embodiment, the invention comprises one or more of the following features, alone or in a technically acceptable combination.

According to one embodiment, the method further comprises the following steps, implemented by the mobile terminal:
transmitting the transmitted information to the server;
receiving the display instructions determined by the server
displaying according to the display instructions on the mobile terminal's display screen.

According to one implementation, the display mode is one among an unsecured display mode and a secure display mode.

According to these provisions, the PIN entry is ensured with a level of security appropriate to the need.

According to one implementation mode, the unsecured mode is characterized in that the input zones displayed on the screen are presented simultaneously on the screen according to a predetermined relative positioning of the zones.

According to these provisions, the PIN entry is ensured with a level of security defined by something other than random positioning, so as to be adapted to the particular needs of visually impaired users.

According to one implementation mode, the secure mode is characterized in that the input zones displayed on the screen are presented simultaneously on the screen according to a random relative positioning of the zones.

According to these provisions, the PIN entry is ensured with a satisfactory level of security appropriate to the need.

According to one implementation mode, the information transmitted by the mobile terminal and received by the server in the reception step is information relating to the mobile terminal.

According to one implementation mode, the information relating to the mobile terminal comprises at least one of an operating system type, an operating system version, a status of a hardware security component, and a list of software components currently running on the mobile terminal.

According to these provisions, the security associated with the PIN entry is adapted to the computing, software, and hardware environment for using the payment application on the mobile terminal.

According to one implementation mode, the transmitted information further comprises a payment card identifier, the risk level being determined, in the information processing step, based on the number of times the same payment card identifier has been successively received by the server over a predetermined period of time.

According to these provisions, the security associated with entering the PIN code is adapted to the context of use of the payment application on the mobile terminal.

According to one embodiment, the information is transmitted securely, for example encrypted.

According to one aspect, the invention also concerns a computer program comprising a set of instructions configured to implement the method according to one of the embodiments described above, when the instructions are executed on a processor of a mobile terminal, and/or on a server processor.

### BRIEF DESCRIPTION OF THE DRAWINGS

For a better understanding, an embodiment and/or implementation mode of the invention is described with reference to the attached drawings representing, by way of non-limiting example, an embodiment or implementation mode respectively of a device and/or a method according to the invention. The same references in the drawings designate similar elements or elements whose functions are similar.

FIG. 1 is a presentation of a display of the entry zones for the PIN code elements according to a determined relative positioning of the zones on the screen.

FIG. 2 is a schematic presentation of the sequencing of the steps implemented by the mobile terminal and by the server.

### DETAILED DESCRIPTION

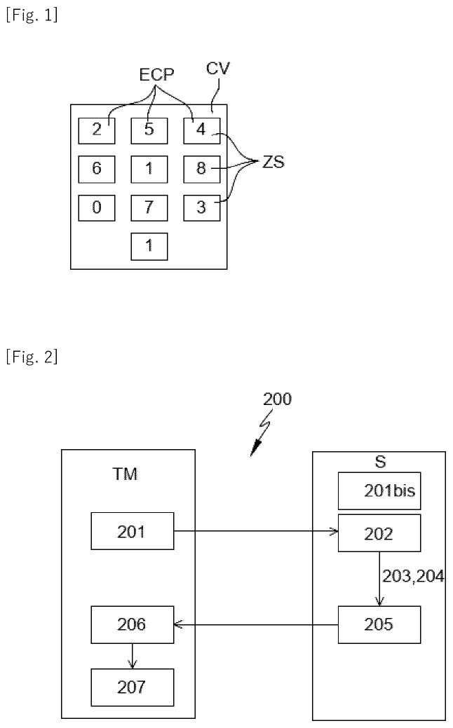

FIG. 1 represents an example of a virtual keyboard, on which the entry zones ZS for the ECP elements of the PIN code are displayed, according to a determined relative positioning of the zones on the screen; the ECP elements of the PIN code are numbers in FIG. 1, but could be letters or other symbols. Similarly; the entry zones ZS of the virtual keyboard CV may take other forms than those shown in FIG. 1.

The virtual keyboard CV of FIG. 1 is generally displayed on a tactile screen of a mobile terminal TM such as the one shown schematically in FIG. 2. Said mobile terminal TM is typically a commercially available mobile terminal TM intended for the general public, provided as standard with a processor configured to communicate with an associated memory and with a screen, for the graphical display of information, for example a tactile screen, the processor, the associated memory, and the screen being adapted to implement the processing associated with the applications installed on the mobile terminal TM; the mobile terminal TM is also provided, as standard, with a data transmission means adapted to communicate with a server S. The mobile terminal TM is, for example, a smart phone, a tablet, or a simple laptop.

Instead of systematically displaying the entry zones ZS of the ECP digits of the PIN code with relative positions randomly arranged on the screen of the mobile terminal TM, a server S, distinct from the mobile terminal TM, is configured to determine, based on information relating to the mobile terminal TM or relating to the context, whether the relative positions of the entry zones ZS of the ECP digits of the PIN code should be arranged randomly, to ensure in a known manner the security required for payment via the mobile terminal TM, or according to a pre-established order, more favorable to visually impaired users, thereby ensuring the required security by alternative means that are not part of the invention.

The steps of the method 200 according to the invention, implemented by the server S, and respectively by the mobile terminal TM, are described below with reference to FIG. 2.

The server S implements the following steps of the method 200 to ensure adaptive security for entering the digits of a personal identification code, known as a PIN code, on the mobile terminal TM:
receiving 202 of information transmitted by the mobile terminal TM; the transmitted information makes it possible to define a security level of the mobile terminal TM; a type of transmitted information may be predetermined, or determined by the server S in a request sent 201bis by the server S to the mobile terminal TM;
processing 203 of the information transmitted by the mobile terminal TM, to determine a risk level;
determining 204 a display mode based on the risk level;
transmitting 205 to the mobile terminal TM of display instructions determined by the server S on the basis of the determined display mode; the display instructions are configured to ensure a display according to the determined display mode of the entry zones ZS of the ECP elements of the PIN code on a display screen of the mobile terminal TM, when the display instructions are executed by a processor of the mobile terminal TM.

Thus, the PIN entry is possible for visually impaired people, and the security associated with the PIN entry is ensured by means other than presenting the input zones ZS on the screen in a random order.

In particular, the method further comprises the following steps implemented by the mobile terminal TM:
transmitting 201 the information to the server S;
receiving 205 the display instructions determined by the server S;
displaying 207 according to the display instructions on the display screen of the mobile terminal TM.

More particularly, the display mode is either unsecured or secure.

For example, the unsecured mode is characterized in that the input zones displayed on the screen are presented simultaneously on the screen according to a predetermined relative positioning of the zones. Thus, the visually impaired users can use the terminal to enter the PIN.

According to another implementation example, the secure mode is characterized in that the entry zones displayed on the screen are presented simultaneously on the screen according to a random relative positioning of the zones. Thus, the PIN entry is ensured with a satisfactory level of security.

The information transmitted by the mobile terminal TM and received by the server S in the reception step 202 may be information relating to the mobile terminal TM; for example, the considered type of information may be one of the following types of information: an operating system type, an operating system version, a status of a security hardware component, or a list of software components currently running on the mobile terminal. According to these provisions, the security associated with the PIN entry is adapted to the computing, software, and hardware environment, of the use of the payment application on the mobile terminal TM.

The information may be transmitted by the mobile terminal TM to the server S in a secure manner, for example, encrypted.

For example, to determine a risk level from the information transmitted by the TM concerning the types of information mentioned above, the server S calculates an indicator representative of possible access by the mobile terminal TM to accelerometric data; the server S determines a risk level based on the existence, on the mobile terminal TM, of access to accelerometric data; according to another example, the server S may determine a risk level based on the hardware or software implementation of certain applications present on the mobile terminal TM.

According to yet another example, the transmitted information may comprise a payment card identifier; in this case, the risk level is determined, in the information processing step 203, based on the number of times the same payment card identifier has been received successively, over a predetermined period of time, by the server S. According to these provisions, the security associated with entering the PIN code is adapted to the context of use of the payment application on the mobile terminal.

According to one aspect, the invention concerns a computer program comprising a set of instructions configured to implement the method (200) according to one of the implementation modes described above, when the instructions are executed on a processor of a mobile terminal TM, and/or on a processor of the server S.

Although the present disclosure has been described with reference to one or more examples, workers skilled in the art will recognize that changes may be made in form and detail without departing from the scope of the disclosure and/or the appended claims.

1. A method for adaptively securing entry of elements of a personal identification code, called a PIN code, on a mobile terminal configured to communicate with a server, the method comprising:
the following acts implemented by the server:
receiving information transmitted by the mobile terminal, the transmitted information making it possible to define a security level of the mobile terminal, a type of transmitted information being predetermined, or determined by the server in a request sent by the server to the mobile terminal;
processing the information transmitted by the mobile terminal, to determine a risk level;
determining a display mode based on the risk level; and
transmitting to the mobile terminal display instructions determined by the server based on the determined display mode, the display instructions being configured to ensure a display according to the display mode of entry zones of the elements of the PIN code on a display screen of the mobile terminal.

2. The method according to claim 1, the method further comprising the following acts, implemented by the mobile terminal:
transmitting the transmitted information to the server;
receiving the display instructions determined by the server; and
displaying according to the display instructions on the display screen of the mobile terminal.

3. The method according to claim 1, wherein the display mode is one of an unsecured display mode and a secure display mode.

4. The method according to claim 3, wherein the unsecured mode is characterized in that the entry zones displayed on the screen are presented simultaneously on the screen according to a predetermined relative positioning of the zones.

5. The method according to claim 3, wherein the secure mode is characterized in that the entry zones displayed on the screen are presented simultaneously on the screen according to a random relative positioning of the zones.

6. The method according to claim 1, wherein the information transmitted by the mobile terminal and received by the server in the receiving is information relating to the mobile terminal.

7. The method according to claim 6, wherein the information relating to the mobile terminal comprises at least one of an operating system type, an operating system version, a status of a security hardware component, and a list of software components currently running on the mobile terminal.

8. The method according to claim 1, wherein the transmitted information further comprises a payment card identifier, the risk level being determined, in the information processing step, based on the number of times the same payment card identifier has been received successively, over a predetermined period of time, by the server.

9. The method according to claim 1, wherein the information is transmitted in a secure manner.

10. A non-transitory computer readable medium comprising a computer program stored thereon comprising a set of instructions configured to implement a method for adaptively securing entry of elements of a personal identification code, called a PIN code, on a mobile terminal when the instructions are executed on a processor of a server, the mobile terminal being configured to communicate with the server, and the method comprising:
receiving information transmitted by the mobile terminal, the transmitted information making it possible to define a security level of the mobile terminal, a type of transmitted information being predetermined, or determined by the server in a request sent by the server to the mobile terminal;
processing the information transmitted by the mobile terminal, to determine a risk level;
determining a display mode based on the risk level; and
transmitting to the mobile terminal display instructions determined by the server based on the determined display mode, the display instructions being configured to ensure a display according to the display mode of entry zones of the elements of the PIN code on a display screen of the mobile terminal.
